(19) United States
(12) Patent Application Publication
(10) Pub. No.: US 2026/0129453 A1
(43) Pub. Date: May 7, 2026

(54) MITIGATION FOR MAN-IN-THE-MIDDLE AND REPLAY ATTACKS WITHIN A MOBILITY DOMAIN

(71) Applicant: Cisco Technology, Inc., San Jose, CA (US)

(72) Inventors: Binita GUPTA, San Diego, CA (US); Brian D. HART, Sunnyvale, CA (US); Stephen M. ORR, Wallkill, NY (US); Malcolm M. SMITH, Richardson, TX (US); Indermeet S. GANDHI, San Jose, CA (US)

(21) Appl. No.: 19/348,742

(22) Filed: Oct. 2, 2025

Related U.S. Application Data
(60) Provisional application No. 63/715,442, filed on Nov. 1, 2024.

(51) Int. Cl. H04W 12/128

(52) U.S. Cl. CPC H04W 12/128

(57) ABSTRACT

The present disclosure provides techniques for mitigating Man-in-the-Middle (MITM) and replay attack within a mobility domain. An access point (AP) within a seamless mobility domain (SMD), generates a frame comprising an SMD signature, an SMD identifier, and a replay protection value, where the SMD signature is generated by signing a data structure comprising the SMD identifier and the replay protection value using a private key associated with the SMD. The AP transmits the frame to a station (STA) for verification.

### CROSS-REFERENCE TO RELATED APPLICATIONS

This application claims benefit of co-pending U.S. provisional patent application Ser. No. 63/715,442 filed Nov. 12, 2024. The aforementioned related patent application is herein incorporated by reference in its entirety.

### TECHNICAL FIELD

Embodiments presented in this disclosure generally relate to wireless communication. More specifically, embodiments disclosed herein relate to mitigating Man-in-the-Middle (MITM) and replay attacks within a mobility domain.

### BACKGROUND

Wireless networks are evolving to support seamless mobility across extended service sets (ESS), such as campus-wide or enterprise-wide deployments. To reduce handoff latency and improve user experience during roaming, mechanisms have been introduced that allow stations (STAs) to maintain continuous connectivity while moving between multiple access points (APs) within the same mobility domain. However, as roaming becomes more seamless and decentralized, the risk of replay attacks increases. Existing protection often relies on per-link key management and sequence number tracking but does not provide verification of membership in a scalable and low-latency manner.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example of client roaming within a seamless mobility domain (SMD), according to some embodiments of the present disclosure.

FIG. 2 depicts an example of a roaming replay attack scenario during client roaming in an SMD, according to some embodiments of the present disclosure.

FIG. 3 depicts an example sequence of interaction between a station multi-link device (STA MLD) and a target access point multi-link device (AP MLD) during roaming, according to some embodiments of the present disclosure.

FIG. 4 depicts an example sequence of interaction between a STA MLD and a target AP MLD during roaming, according to some embodiments of the present disclosure.

FIG. 5 depicts an example method performed by a target AP MLD for seamless mobility domain (SMD) signature transmission, according to some embodiments of the present disclosure.

FIG. 6 depicts an example method performed by a STA MLD to verify a target AP using an SMD signature and a replay protection value, according to some embodiments of the present disclosure.

FIG. 7 depicts an example method performed by a target AP MLD for SMD signature-based liveness verification using a nonce exchange, according to some embodiments of the present disclosure.

FIG. 8 depicts an example method performed by a STA MLD to verify a target AP using an SMD signature with liveness verification, according to some embodiments of the present disclosure.

FIG. 9 is a block diagram depicting an example method performed by a STA MLD for verifying an AP MLD using an SMD signature and a replay protection value, according to some embodiments of the present disclosure.

FIG. 10 is a block diagram depicting an example method performed by an AP MLD for transmitting an SMD signature with a replay protection value, according to some embodiments of the present disclosure.

FIG. 11 is a block diagram depicting an example method performed by a STA MLD for verifying an AP MLD using a nonce exchange and live SMD signature, according to some embodiments of the present disclosure.

FIG. 12 is a block diagram depicting an example method performed by an AP MLD for generating and transmitting a live SMD signature in response to a STA-initiated nonce exchange, according to some embodiments of the present disclosure.

FIG. 13 depicts an example client device configured to perform various aspects of the present disclosure, according to some aspects of the present disclosure.

FIG. 14 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including receiving, by a station (STA), a frame transmitted by an access point (AP), where the STA is a member of a seamless mobility domain (SMD) and the frame comprises an SMD signature, an SMD identifier, and a replay protection value, reconstructing, by the STA, a data structure using the SMD identifier and the replay protection value, verifying, by the STA, using a public key associated with the SMD, the SMD signature against the data structure, and determining, based on successful verification of the SMD signature, that the AP is a valid member of the SMD.

One embodiment presented in this disclosure provides a method, including generating, by an access point (AP) within a seamless mobility domain (SMD), an SMD signature, an SMD identifier, and a replay protection value, where the SMD signature is generated by signing a data structure comprising the SMD identifier and the replay protection value using a private key associated with the SMD, and transmitting, by the AP, the frame to a station (STA) for verification.

One embodiment presented in this disclosure provides a method, including receiving, by a station (STA), a frame transmitted by an access point (AP), where the STA is a member of a seamless mobility domain (SMD) and the frame comprises a static SMD signature and an SMD identifier, transmitting, by the STA, a client nonce (CNonce) to the AP, receiving, by the STA and from the AP, a live SMD signature generated based on the CNonce, an AP nonce (ANonce), and the SMD identifier using a private key associated with the SMD, verifying, by the STA, the live SMD signature using a public key associated with the SMD, and determining, based on successful verification of the live SMD signature, that the AP is a valid member of the SMD.

One embodiment presented in this disclosure provides a method, including generating, by an access point (AP) within a seamless mobility domain (SMD), a frame comprising a static SMD signature, and an SMD identifier, transmitting, by the AP, the frame to a station (STA), receiving, by the AP, a client nonce (CNonce) from the STA, generating, by the AP, an AP nonce (ANonce), generating a live SMD signature by signing a data structure comprising the CNonce, the ANonce, and the SMD identifier using a private key associated with the SMD, and transmitting, by the AP, the live SMD signature to the STA for verification.

### EXAMPLE EMBODIMENTS

Wireless networks are evolving to support seamless mobility and low-latency roaming, particularly in enterprise or campus-wide environments. In such networks, a client device (station or STA) may establish a secure association with an extended service set (ESS) instead of with an individual access point (AP). The ESS may represent a campus-wide network or global network spanning multiple campuses. In cases where the ESS spans multiple campuses, the network may define sub-mobility domains, each mapped to a single campus. In these configurations, a sub-mobility domain identifier may be signaled in addition to the mobility domain identifier.

As used herein, the term “association” refers to the establishment of a data path between a STA and an access point multi-link device (AP MLD), including the selection of the AP for data plane communication. The process typically involves exchanging capability information and completing the association handshake defined by IEEE 802.11. The term “secure association,” as used herein, refers specifically to the establishment of a cryptographic security context between the STA and the AP MLD, including the derivation and installation of unicast encryption keys (e.g., pairwise transit key (PTK)) used to protect unicast traffic. The security context may be derived through authentication protocols. Under this architecture, the STA forms a secure association with a mobility domain multi-link device (MLD). As used herein, the mobility domain MLD refers to a logical entity representing the mobility domain covering multiple AP MLDs in the ESS. This allows the STA to roam between APs within the mobility domain without repeating the full association and key derivation process at each node. Such an architecture can significantly reduce handover latency to realize seamless roaming.

To authenticate APs as members of the correct mobility domain, the system may use a seamless mobility domain (SMD) signature (also referred to in some embodiments as mobility domain multi-link (MDM) signature). The signature allows the STA to verify that a beacon frame originates from a legitimate AP belonging to the mobility domain MLD. However, a rogue AP may capture a valid SMD signature from a genuine beacon and later replay it on the same operating channel to impersonate a legitimate AP. This creates a vulnerability to Man-in-the-Middle (MITM) attacks, where a rogue AP positions itself between the STA and the network.

The present disclosure provides methods, systems, and apparatuses for mitigating such replay and MITM attacks. In one embodiment, replay protection is achieved through passive verification. Each beacon frame includes the SMD signature, an SMD identifier (also referred to in some embodiments as a mobility domain MLD identifier (MDMI)), and a replay protection value (e.g., a nonce or replay counter). The STA reconstructs the signed data structure using the SMD identifier, the replay protection value, and optionally one or more fields such as the AP identifier (ID), operating channel, or a timestamp. The STA obtains a trusted public key corresponding to the mobility domain via one of three mechanisms: trust-on-first-use (TOFU), public key infrastructure (PKI), or a certificate signed by a trusted certificate authority (CA). Using the reconstructed structure and the public key, the STA verifies the SMD signature to determine whether the beacon(s) originates from an authorized AP.

In another embodiment, active verification is used when including a replay protection value in every beacon may be undesirable (e.g., to reduce cryptographic compute overhead or avoid requiring each AP MLD to communicate the SMD private key holder every beacon interval). In such configurations, the STA performs a client-AP exchange for active verification. Upon receiving a beacon, the STA sends a client nonce (CNonce) to the AP. The AP generates an AP nonce (ANonce) and forwards both nonces, along with identifying information (e.g., SMD identifier, AP MAC address, channel number), to the SMD key holder. The key holder signs the data bundle to generate a live SMD signature, which is then returned to the STA. The STA verifies the live signature using the known public key. Successful verification confirms both the AP's domain membership and the liveness of the response.

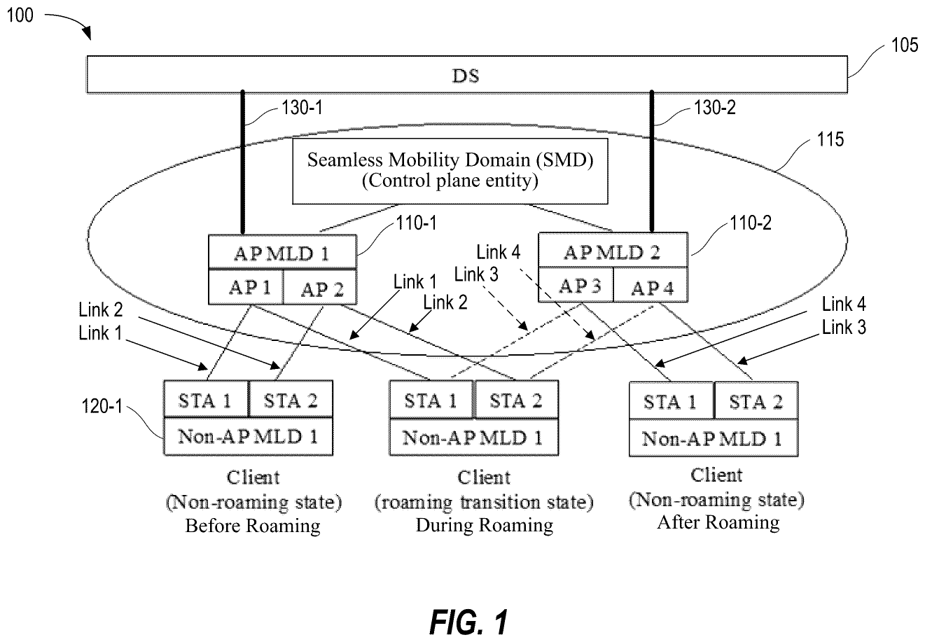

FIG. 1 depicts an example 100 of client roaming within a seamless mobility domain (SMD), according to some embodiments of the present disclosure.

In this example 100, two access point multi-link devices (AP MLDs) 110-1 and 110-2 are provided, each including two affiliated AP radios. Specifically, AP MLD 1 includes AP 1 and AP 2, and AP MLD 2 includes AP 3 and AP 4. Both AP 110-1 and 110-2 are part of the same seamless mobility domain (SMD) 115.

As used herein, an SMD refers to a logical control plane entity that enables seamless client roaming across multiple AP MLDs. The SMD may also be referred to as a mobility domain MLD, which represents the collective identity of the set of AP MLDs that share a common secure association context for roaming clients. An extended service set (ESS) may correspond to a single SMD, or may be divided into multiple SMDs or sub-mobility domains, for example, in a global-network setting spanning multiple campuses. In such configurations, a sub-mobility domain identifier may be signaled in addition to the SMD identifier to distinguish among different SMD partitions.

As used herein, each SMD is uniquely identified within the network by a virtual SMD media access control (MAC) address or an SMD identifier, and each AP MLD is statically configured with the SMD to which it belongs. Affiliated APs (e.g., AP 1 or AP 2) of each AP MLD advertise the associated SMD information in management frames such as beacons and probe responses. Each AP MLD maintains its own MAC service access point (MAC SAP) interface to the distribution system (DS). As depicted, AP MLD 1 (110-1) connects to the distribution system (DS) 105 through MAC SAP 1 (130-1), and AP MLD 2 (110-2) connects to the DS 105 through MAC SAP 2 (130-2).

As depicted, the client device is a non-AP MLD 120-1, also referred to in some embodiments as a station multi-link device (STA MLD), which includes two affiliated radios, STA 1 and STA 2. To initiate communication within the SMD 115, the STA MLD 120-1 performs authentication and association procedures with AP MLD 1 (110-1) and therefore establishes two initial links: Link 1 and Link 2. As depicted, Link 1 connects STA 1 to AP 1, and Link 2 connects STA 2 to AP 2. The SMD 115 maintains the control plan state for the client 120-1, including association information, security context, and capability parameters.

During roaming, the non-AP MLD 120-1 establishes new links with the target AP MLD 2 (110-2), forming Link 3 that connects STA 1 to AP 3 and Link 4 that connects STA 2 to AP 4. The intermediate state enables the client to maintain simultaneous connectivity with both the serving and target AP MLDs and achieves make-before-break roaming. More specifically, the non-AP MLD 120-1 maintains downlink (DL) wireless connectivity with both AP MLDs 110 to receive any buffered DL data from the serving AP MLD 110-1. For uplink (UL) traffic, the non-AP MLD 120-1 maintains connectivity with only one AP MLD 110 at a time, first with the source AP MLD 110-1 and then with the target AP MLD 110-2 after reassociation is completed.

Once the transition is complete, the non-AP MLD 120-1 disassociates from AP MLD 110-1 and removes Link 1 and Link 2. The non-AP MLD 120-1 maintains Link 3 and Link 4 for ongoing communication through AP MLD 2 (110-2). Because the STA maintains a secure association with the SMD rather than with an individual AP, no full reassociation or reestablishment of context is needed during the transition. This approach supports fast and seamless roaming across MAP MLDs within the mobility domain.

When the STA MLD 120-1 initiates roaming, it detects nearby APs, including AP MLD 2 (110-2) by passively scanning for beacon frames. These beacons may include an SMD identifier (also referred to in some embodiments as a MDMI) and a corresponding SMD signature (also referred to in some embodiments as an SMD signature), which is intended to indicate that the broadcasting AP is a valid member of the SMD 115. Upon receiving such a beacon, the STA MLD 120-1 evaluates whether to establish new links (e.g., Links 3 and 4) based on advertised parameters such as channel conditions, load, or signal strength.

However, a malicious or rogue AP may intercept and record a valid beacon including an SMD signature from a legitimate AP and later replay that beacon on the same channel (masquerading as a member of the SMD 115). If the STA MLD 120-1 accepts the replayed beacon as authenticated, it may attempt to associate with the rogue AP and therefore expose the session to a MITM attack.

In some embodiments, the SMD signature and SMD identifier may also be included in other IEEE 802.11 management frames, such as a probe response transmitted by APs in response to probe requests sent by the STA MLD 1. Similar replay and impersonation risks exist in this context, where an attacker may intercept a valid probe response from a genuine AP and replay it later to deceive the STA into initiating roaming toward the rogue device.

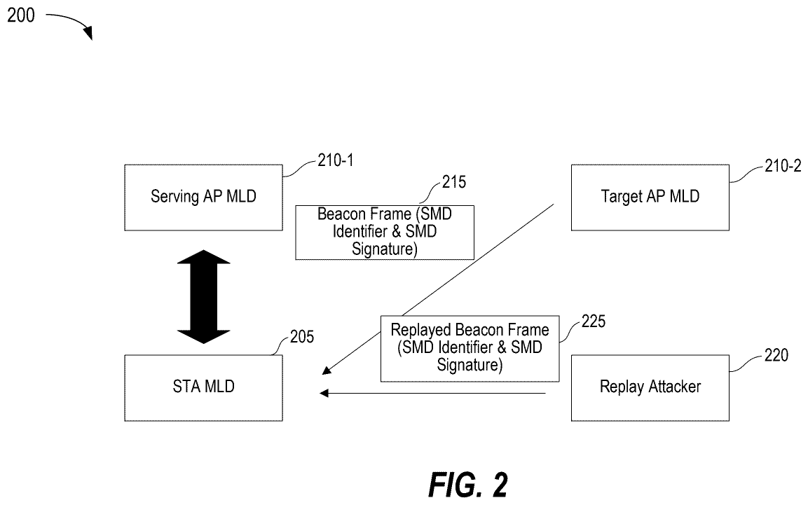

The present disclosure provides mechanisms that enable the STA to verify whether the AP is a legitimate and live member of the claimed mobility domain 115. These mechanisms include either passive verification (e.g., checking that the SMD signature includes a fresh replay protection value like a nonce or replay counter) or active verification (e.g., initiating a challenge-response exchange using client and AP nonces to obtain a live SMD signature). These techniques are designed to detect replayed signatures and confirm AP authenticity. More details regarding replay attacks are discussed below with reference to FIG. 2.

FIG. 2 depicts an example 200 of a roaming replay attack scenario during client roaming in an SMD, according to some embodiments of the present disclosure.

As depicted, a STA MLD 205 is initially associated with a serving AP MLD 210-1. The serving AP MLD 210-1 corresponds to AP MLD 1 (110-1) as depicted in FIG. 1, and the target AP MLD 210-2 corresponds to AP MLD 2 (110-2) as depicted in FIG. 1. Both AP MLDs 210-1 and 210-2 are members of the same SMD (e.g., 115 of FIG. 1). While roaming, the STA MLD 205 scans and receives beacon frames 215 from the target AP MLD 210-2.

In this example 200, the beacon frame 215 transmitted by AP MLD 210-2 includes an SMD identifier and a corresponding SMD signature. The SMD signature indicates the target AP's live and legitimate domain membership.

A replay attacker 220 positioned within radio range intercepts the Beacon frame 215 transmitted by the legitimate target AP MLD 210-2. At a later time, the attacker 220 replays the captured Beacon frame (shown as replayed Beacon frame 225) to the STA MLD 205. Because the Beacon 225 includes a previously valid SMD signature and SMD identifier, and appears structurally identical to a genuine advertisement, the STA MLD 205 may erroneously interpret the attacker 220 as a legitimate AP MLD belonging to the SMD. The STA MLD 205 may then initiate a roaming request to the attacker 220 and attempt to establish new wireless links. This results in a MITM condition, where the attacker 220 is positioned between the STA and the legitimate distribution system. The attacker 220 may therefore intercept or modify traffic, capture authentication exchanges, or exploit other protocol behaviors to compromise confidentiality or availability of the wireless session.

In some embodiments, the SMD signature and SMD identifier may also be included in other management frames, such as probe responses that are sent in response to probe requests from roaming STAs. These probe responses are similarly vulnerable. An attacker may capture and replay a valid probe response frame including a legitimate SMD signature and SMD identifier, use the response to impersonate an authorized AP, and trigger an illegitimate association attempt.

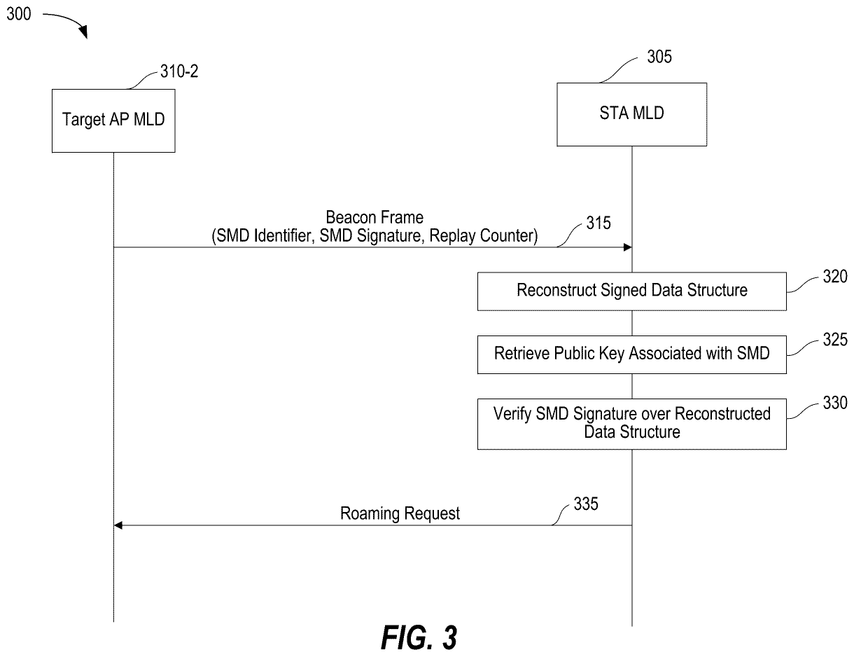

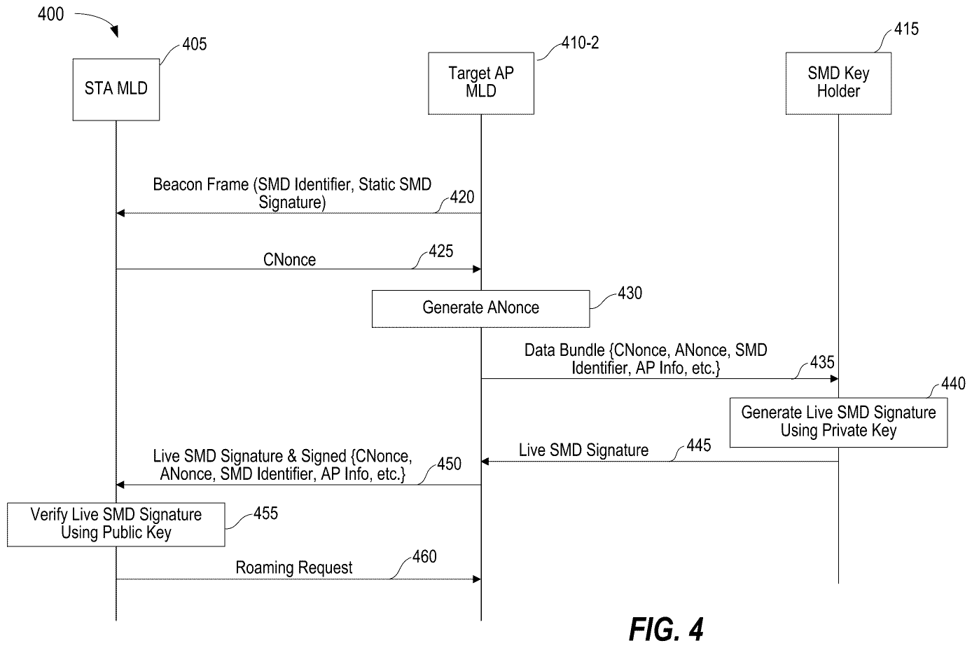

As discussed in further detail with reference to FIGS. 3-4, the present disclosure provides mechanisms that enable the STA MLD 205 to verify whether an AP is a legitimate and live member of the SMD. These techniques allow the STA MLD 205 to detect replayed beacon frames 225 and prevent illegitimate roaming associations with rogue APs (e.g., attacker AP 220).

FIG. 3 depicts an example sequence of interaction 300 between a STA MLD and a target AP MLD during roaming, according to some embodiments of the present disclosure. In the depicted example sequence 300, the STA MLD verifies the target AP's legitimacy using an SMD signature and a replay protection value.

The STA MLD 305 may correspond to non-AP MLD 1 (120-1) as depicted in FIG. 1 or STA MLD 205 as depicted in FIG. 2. The target AP MLD 310-2 may correspond to AP MLD 2 (110-2) as depicted in FIG. 1 or target AP MLD 210-2 as depicted in FIG. 2. The SMD key holder possesses the private key used to generate the SMD signature for the SMD.

As used herein, the SMD identifier refers to a unique identifier associated with an SMD or mobility domain MLD. In some embodiments, the SMD identifier may be implemented as a virtual MAC address that represents the logical identity of the SMD. In configurations with sub-mobility domains, an additional sub-mobility domain identifier may be included in the beacon frame along with the SMD identifier to identify the specific sub-region of the overall mobility domain.

As used herein, the SMD signature is a cryptographic signature generated by a trusted entity within the SMD (e.g., a key holder associated with the mobility domain) and serves to prove the authenticity and domain membership of the broadcasting AP. The SMD signature is computed over a structured set of fields that describe the AP and its operation parameters, and is signed using a private key associated with the SMD.

At step 315, the target AP MLD 310-2 transmits a beacon frame to the STA MLD 305. The STA MLD 305 is currently associated with a serving AP MLD and is seeking to roam to another AP within the same SMD, for example, due to improved signal strength or reduced channel congestion.

The beacon frame includes the SMD identifier, the SMD signature, and a replay protection value, which may be a nonce or a replay counter. These elements allow the STA 305 to determine whether the SMD signature is fresh and generated specifically for that beacon transmission. The beacon may also include other signal fields such as channel condition metrics, AP identification information (e.g., The AP MLD's media access control (MAC) address or basic service set identifier (BSSID)), an operating channel number, and a timestamp or validity interval. In some embodiments, the SMD identifier, SMD signature, and replay protection value may be included in other management frames, such as probe responses.

The SMD signature is generated by the AP using a replay protection value that is valid for a defined time interval. When the time interval expires, a new replay protection value is generated and a new SMD signature is created to reflect the updated context.

At step 320, the STA MLD 305 extracts the SMD identifier, SMD signature, replay protection value, and the additional signed fields from the received beacon. The STA MLD 305 then reconstructs the original data structure that was used to generate the SMD signature by assembling the extracted values in a defined format. The reconstruction precisely matches the structure that the signing entity used, both in field order and content, to ensure that the verification step is valid.

At block 325, the STA MLD 305 retrieves or references a trusted public key associated with the SMD. The public key may have been acquired in various manners. In some embodiments, the STA may adopt a TOFU model, where the STA stores and trusts the first valid public key received in association with a given SDM identifier. The public key is received over-the-air from the associated AP. In some embodiments, the STA may operate within a PKI, where the STA obtains the public key through structured key distribution and verifies it against configured domain policies. In this configuration, the public key is provisioned on the STA. In some embodiments, the STA MLD 305 may receive the public key as part of a digital certificate signed by a trusted certificate authority (CA) and validate the certificate chain using one or more pre-installed root certificates. In some embodiments, the STA may receive the public key associated with the SMD from the AP through the Access Network Query Protocol (ANQP) request/response exchange.

At step 330, the STA MLD 305 uses the trusted public key to verify the SMD signature against the reconstructed data structure. The verification process may include cryptographically computing a hash of the reconstructed data structure, which includes the SMD identifier (or sub-mobility domain ID), the replay protection value (e.g., a nonce or replay counter), and any additional signed fields (e.g., AP identity information, channel number, or timestamp). The STA MLD 305 then applies a signature verification algorithm (e.g., elliptic curve digital signature algorithm (ECDSA) or Rivest-Shamir-Adleman (RSA)) using the public key. The verification algorithm checks whether the provided SMD signature is a valid digital signature over the computed hash when interpreted under the known public key. The check confirms that the SMD signature could only have been generated using the private key corresponding to the trusted public key. If the verification succeeds, the STA infers that (i) the beacon originated from an authorized AP MLD that holds valid credentials for the SMD, and (ii) the beacon is fresh (or new), based on the uniqueness of the included replay protection value.

Upon successful verification, at step 335, the STA MLD 305 proceeds to initiate a roaming request to the target AP MLD 310-2. The roaming request indicates the STA's intent to connect and initiates the roaming procedure under the secure association established with the mobility domain. If the signature verification fails (e.g., due to a mismatched hash), the STA discards the beacon and refrains from initiating a roaming request to the advertising AP. The disclosed verification mechanism enables the STA to authenticate the legitimacy of the target AP using broadcasted (or transmitted) information, thereby mitigating the risk of replay attacks during roaming within a mobility domain.

In some embodiments, it may be preferred not to generate a new SMD signature in every beacon interval. In such cases, the SMD signature may omit the nonce or replay counter, due to several practical considerations. For example, generating a new public key signature on every beacon can impose significant computing overhead on the network. Additionally, including a fresh signature per beacon may require frequent communication between each AP MLD and the centralized SMD private key holder, which can strain backhaul links and affect scalability (particularly in large deployments or when fast beacon intervals are used). Although second-level certificate degradation may mitigate some of this load, overhead remains a concern in dense mobility domains.

Furthermore, even in systems where the SMD signature includes a replay protection value and operating channel information, the signature may still be vulnerable to delayed replay. For example, an attacker may replay a previously valid beacon on the same channel after the genuine AP has moved to a different channel or been disabled. The delayed replay tricks the STA into associating with a rogue AP that appears to belong to the same SMD.

Both of these scenarios increase the risk of a rogue AP MLD masquerading as a legitimate member of the mobility domain. To address this, the present discourse introduces an active verification mechanism based on a nonce exchange between the STA MLD and the target AP. The mechanism allows the STA to verify the liveness of the SMD signature and confirm that the AP is an active and authorized entity within the domain.

FIG. 4 depicts an example sequence of interaction 400 between a STA MLD and a target AP MLD during roaming, where the STA performs a nonce exchange to authenticate the AP and verify the legitimacy of the SMD signature, according to some embodiments of the present disclosure.

The STA MLD 405 may correspond to non-AP MLD 1 (120-1) as depicted in FIG. 1 or STA MLD 205 as depicted in FIG. 2. The target AP MLD 410-2 may correspond to AP MLD 2 (110-2) as depicted in FIG. 1 or target AP MLD 210-2 as depicted in FIG. 2.

At step 420, the target AP MLD 410-2 transmits a beacon frame to the STA MLD 405. The beacon frame includes an SMD identifier and a static SMD signature. The static SMD signature indicates the AP's claimed membership in the SMD. In some embodiments, the beacon may also include either the public key associated with the SMD or just the SMD identifier. If the public key is not directly included, the STA 405 may use the SMD identifier as an identifier to retrieve or reference the corresponding public key from a local trust store or from prior provisioning. In some embodiments, the SMD identifier and SMD signature may be included within a probe response.

Upon receiving the beacon, the STA evaluates whether to initiate a roaming procedure based on factors such as signal strength, advertised load, or channel conditions. Because the beacon does not include a replay protection value and the static SMD signature may be reused over multiple intervals, the STA determines that passive verification may be insufficient. To verify the liveness and authenticity of the target AP MLD 410-2, the STA proceeds with a liveness verification exchange procedure starting at step 425.

At step 425, the STA MLD 405 transmits a client nonce (CNonce) to the target AP MLD 410-2. The CNonce is a random value generated by the STA for the purpose of initiating a liveness verification exchange. In some embodiments, the CNonce may be transmitted as part of a management frame, such as Fast BSS Transition (FT) authentication request, (re) association request, or other suitable management frame.

At step 430, the target AP MLD 410-2 generates a second random value (ANonce). The AP then constructs a data bundle comprising the CNonce, the ANonce, the SMD identifier, AP identification information (e.g., AP MAC address or BSSID), the operating class, and the channel number. At step 435, the target AP forwards the bundle data to the SMD key holder 415, which possesses the private key associated with the SMD.

At step 440, the SMD key holder 415 uses its private key to digitally sign the data tuple and generate a live SMD signature. The resulting live SMD signature binds the nonces and AP identity to a cryptographic proof of domain membership.

At step 445, the SMD key holder 415 returns the live SMD signature to the target AP MLD 410-2. At step 450, the target AP transmits the live SMD signature, along with the signed fields {CNonce, ANonce, SMD Identifier, AP Info, etc.}, to the STA MLD 405. The response may be conveyed using the same protocol channel as the original CNonce (e.g., FT authentication response or an information element within a (re)association response).

At step 455, the STA MLD 405 verifies the live SMD signature using the trusted public key corresponding to the SMD. The STA computes the hash of the received data structure and performs signature verification using a cryptographic algorithm (e.g., ECSDA). If the signature is valid, the STA MLD 405 confirms that the target AP is an authorized and live member of the SMD, and that the beacon frame is fresh. At step 460, upon successful verification, the STA MLD 405 transmits a roaming request to the target AP MLD 410-2.

If the verification fails, such as due to a mismatched hash, the STA MLD 405 determines that the beacon is either replayed or not generated by an authorized member of the SMD. In such cases, the STA 405 infers that the target AP may be a rogue device or that the SMD signature lacks freshness or authenticity. The failure condition prevents the STA MLD 405 from proceeding with the roaming process. As a result, the STA MLD 405 discards the beacon and refrains from sending a roaming request or establishing any new links with the target AP MLD 410-2.

The message exchange as depicted in FIG. 4 may be realized using fast BSS transition (FT) association. The liveness verification exchange procedure introduces an additional interaction between the STA and the target AP MLD. As such, some client devices may not support this active verification flow by default and may instead rely solely on passive validation of the static SMD signature included in the Beacon. In these cases, roaming decisions are made based only on the received signature without nonce-based freshness verification.

In embodiments where nonce or replay counter fields are omitted from the SMD signature to reduce computational load or avoid backhaul signaling from APs to the SMD key holder, the absence of a replay protection value may act as a trigger for the STA 405 to initiate the active verification process. More specifically, when the STA MLD 405 detects that the beacon includes an SMD signature without a corresponding nonce or replay counter, it may automatically perform the nonce exchange described above to verify liveness and mitigate the risk of replay attacks.

In some embodiments, instead of forwarding the CNonce and ANonce to an external SMD key holder (e.g., a centralized wireless controller), the target AP MLD 410-2 may be provisioned with the private signing key and independently generates the live SMD signature locally. This approach eliminates backhaul dependency and reduces verification latency.

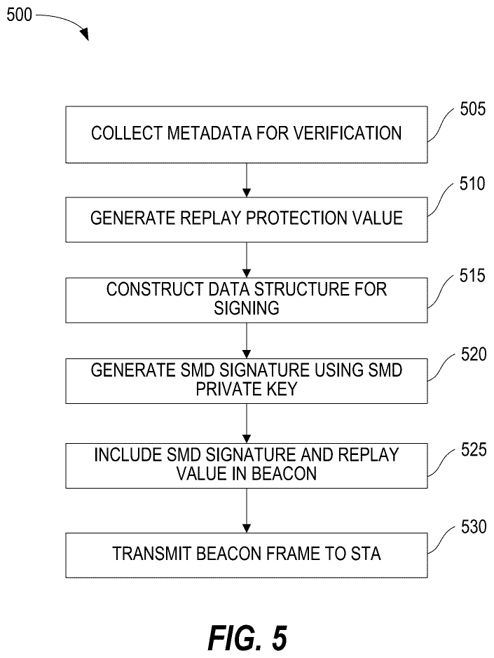

FIG. 5 depicts an example method 500 performed by a target AP MLD for SMD signature transmission, according to some embodiments of the present disclosure.

At block 505, a target AP MLD (e.g., AP MLD 310-2 of FIG. 3) collects one or more fields that are to be used in the signature generation process and included in a beacon frame. The metadata may include the SMD IDENTIFIER (or sub-mobility domain ID), the AP's MAC address or BSSID, the AP's operating channel and class, and optionally a timestamp or time interval value that reflects the beacon generation time or validity duration.

At block 510, the target AP MLD generates a replay protection value, such as a nonce or replay counter, that will be used to ensure freshness (or liveness) of the beacon and prevent replay attacks. The value is unique for each beacon interval and may be incremented or randomly generated. When the current replay protection value expires, for example, after a defined time interval or beacon count, a new replay protection value is generated, and a corresponding new SMD signature is produced and transmitted in the next beacon frame.

At block 515, the AP constructs a structured data tuple comprising the fields (collected at block 505) and the replay protection value (generated at block 510). The data structure is created in a consistent format, such that a receiving STA (e.g., STA 305 of FIG. 3) can reconstruct the same structure for signature verification. Example fields in the structure may include {SMD IDENTIFIER, Replay Projection Value, AP MAC Address, Channel Number, Timestamp}.

At block 520, the AP signs the constructed data structure using a private key associated with the mobility domain. The result is a digital SMD signature, which cryptographically binds the metadata and replay protection value to prove the AP's legitimate membership in the SMD. In some embodiments, the signing operation may be delegated to a centralized entity (e.g., SMD key holder or wireless controller) and cached for reuse.

At block 525, the AP embeds the generated SMD signature, the SMD IDENTIFIER, and the corresponding replay protection value into information elements within a beacon frame.

At block 530, the AP transmits the completed beacon frame, including the embedded signature, SMD IDENTIFIER, and replay protection value, to surrounding STAs. Upon receiving the beacon, the STA may attempt to authenticate the AP and validate the freshness of the beacon based on the replay protection value. Specifically, the STA reconstructs the signed data structure using the extracted fields and verifies the SMD signature using a trusted public key corresponding to the SMD.

In some embodiments, the SMD signature, replay protection value, and SMD IDENTIFIER may be included in other IEEE 802.11 management frames, such as a probe response transmitted in response to a probe request from the STA.

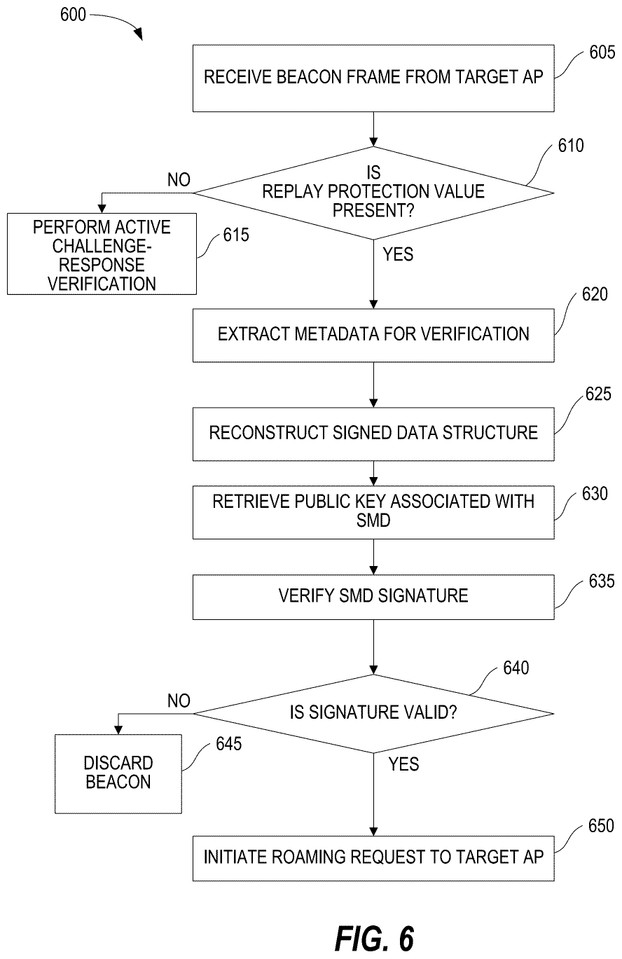

FIG. 6 depicts an example method 600 performed by a STA MLD to verify a target AP using an SMD signature and a replay protection value, according to some embodiments of the present disclosure.

At block 605, a STA MLD (e.g., STA MLD 305 of FIG. 3) receives a beacon frame or other management frame (e.g., probe response) from a target AP MLD (e.g., AP MLD 310-2 of FIG. 3). The frame includes cryptographic and operational metadata, such as the SMD IDENTIFIER and an SMD signature.

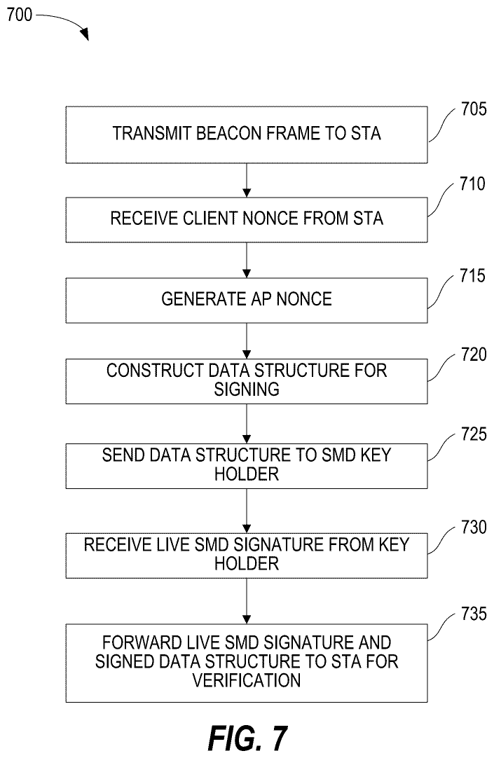

At block 610, the STA checks whether the replay protection value is included in the received frame. If the field is absent, the method 600 moves to block 615, where the STA determines the signature as unverifiable under passive mode and proceeds to perform an active challenge-response method (as depicted in FIGS. 4 and 7). If the field is present, the method 600 proceeds to block 620.

At block 620, the STA extracts the SMD IDENTIFIER, SMD signature, replay protection value (e.g., a nonce or replay counter), and any additional signed parameters (e.g., AP MAC address, operating channel, timestamp) from the received frame.

At block 625, the STA reconstructs the expected signed data structure using the extracted fields. The structure matches the format used during SMD signature generation by the AP.

At block 630, the STA retrieves a trusted public key associated with the SMD. The trusted public key may be obtained using TOFU, a PKI, or a certificate signed by a trusted CA. The SMD IDENTIFIER may serve as a lookup key to identify the appropriate public key.

At block 635, the STA performs cryptographic verification of the SMD signature using the trusted public key. Specifically, the STA first computes a cryptographic hash of the reconstructed data structure (which includes the SMD IDENTIFIER, replay protection value, and any other signed fields). The STA then applies a digital signature verification algorithm (e.g., ECDSA) to confirm whether the received SMD signature is valid for the hashed data under the corresponding public key. The operation confirms both the authenticity of the AP and the integrity of the received data frame.

At block 640, the STA checks the result of the signature verification operation. If the signature is valid (e.g., the signature was generated using the private key associated with the trusted SMD public key and matches the reconstructed data), the method proceeds to block 650, where the STA initiates a roaming request to the target AP MLD. If the signature verification fails (e.g., due to a mismatched hash or an untrusted key), the method proceeds to block 645, where the STA discards the beacon or management frame and takes no roaming action towards the target AP.

FIG. 7 depicts an example method 700 performed by a target AP MLD for SMD signature-based liveness verification using a nonce exchange, according to some embodiments of the present disclosure.

At block 705, a target AP (e.g., AP MLD 410-2 of FIG. 4) transmits a beacon frame that includes the SMD IDENTIFIER and a static SMD signature. The static signature indicates the AP's claimed membership in the SMD but does not include a per-frame freshness value (e.g., a replay protection value). Therefore, the Beacon requires further validation. In some embodiments, the information may be included in other management frames such as a probe response, which is transmitted in response to a probe request from a scanning STA.

At block 710, the AP receives a client nonce (CNonce) from a STA (e.g., STA 405 of FIG. 4). The message may be delivered through a FT authentication request, (re) association request, or other action frames.

At block 715, in response to receiving the CNonce, the AP generates its own AP nonce (ANonce). The ANonce is a random or pseudo-random value uniquely generated for the interaction. The AP uses the ANonce and CNonce as inputs for the live signature.

At block 720, the AP constructs a data structure to be signed, including the CNonce, ANonce, SMD IDENTIFIER, AP identification (e.g., MAC address or BSSID), operating class, channel number, timestamp or time interval, and other relevant parameters.

At block 725, the AP transmits the constructed data structure to a trusted SMD key holder. As used herein, the trusted SMD key holder is an entity within the mobility domain that holds the private key associated with the SMD. Upon receiving the request, the SMD key holder generates a live SMD signature by applying a digital signature algorithm (e.g., ECDSA) to a cryptographic hash of the structured data. In some embodiments, the key holder may be implemented as a physical or cloud-based server or a wireless controller.

At block 730, the AP receives the live SMD signature from the SMD key holder. The signature is cryptographically bound to both nonces and the operational metadata, indicating that the AP's response was freshly generated in direct response to the STA's challenge.

At block 735, the AP transmits the live SMD signature along with the associated signed data fields (e.g., CNonce, ANonce, SMD IDENTIFIER, AP MAC address, operating channel) to the requesting STA. The message may be conveyed within a FT authentication response. The forwarded information (e.g., the SMD signature and the signed data) allows the STA to reconstruct and verify the structure independently using a trusted SMD public key. Successful verification at the STA side confirms that the beacon frame (or the probe response frame) was not replayed and that the AP is a live and authorized participant within the advertised mobility domain.

In some embodiments, the AP itself may be provisioned with the SMD private key and directly generate the live SMD signature locally, instead of forwarding the task to an external key holder.

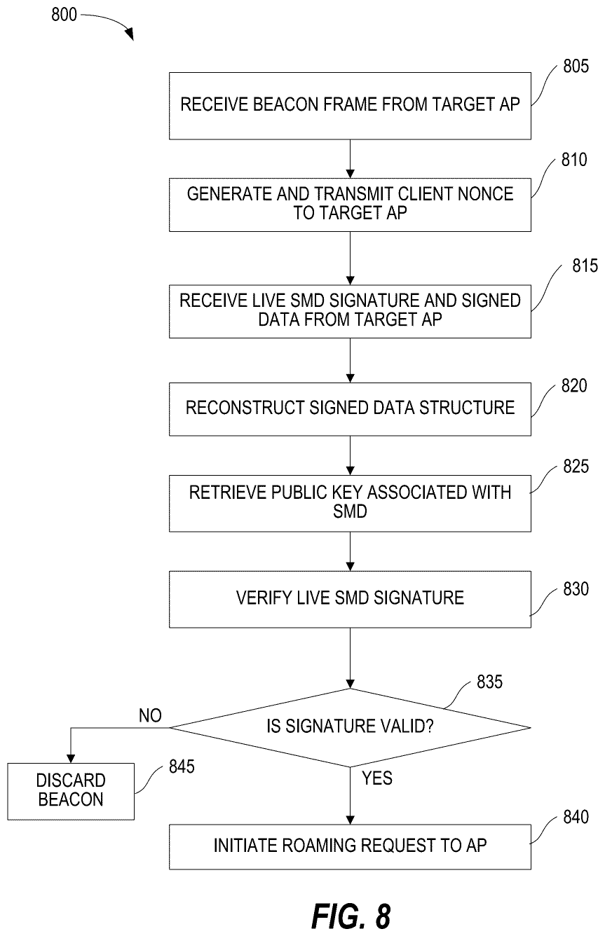

FIG. 8 depicts an example method 800 performed by a STA MLD to verify a target AP using an SMD signature with liveness verification, according to some embodiments of the present disclosure.

At block 805, a STA MLD (e.g., STA 405 of FIG. 4) receives a beacon frame or other management frame (e.g., a probe response frame) from a target AP MLD (e.g., AP MLD 410-2 of FIG. 4). The frame includes an SMD IDENTIFIER and a static SMD signature. The SMD signature indicates that the AP claims membership in the SMD. However, since the Beacon does not include a replay protection value such as a nonce or replay counter, the STA cannot determine whether the signature is new or replayed. As a result, the STA initiates a liveness verification procedure to confirm the authenticity of the AP's response.

At block 810, the STA generates a client nonce (CNonce). The CNonce is a random and session-specific value used to initiate a liveness challenge. The CNonce may be transmitted to the AP in a management frame such as a FT authentication request.

At block 815, the STA receives a live SMD signature and the associated signed fields from the AP. These fields include the CNonce, a newly generated AP nonce (ANonce), and the AP-specific metadata (e.g., MAC address or BSSID, operating class, channel number, timestamp or time interval). The inclusion of the CNonce confirms that the signature is bound to the specific STA's request.

At block 820, the STA reconstructs the data structure expected to have been signed, using the CNonce, ANonce, SMD IDENTIFIER, and the AP's operational information. The reconstruction follows the same format used by the SMD key holder or AP to ensure correct verification.

At block 825, the STA retrieves a trusted public key corresponding to the SMD, using TOFU, a PKI, or a CA-signed certificate. The SMD IDENTIFIER received in the beacon may be used to identify the correct public key associated with the mobility domain.

At block 830, the STA uses the trusted public key to verify the live SMD signature over the reconstructed data structure. The operation may include computing a cryptographic hash over the reconstructed data structure (including fields such as the CNonce, ANonce, SMD IDENTIFIER, AP's MAC address, operating class, and channel number) and checking whether the hash matches the signature value when decrypted using the public key. The use of both the CNonce (generated by the STA) and ANonce (generated by the AP) confirms that the AP is both authorized (e.g., part of the SMD) and live (e.g., the response is fresh and specific to the STA's request).

At block 835, the STA evaluates the result of the signature verification. If the signature is valid, the STA concludes that the AP is a legitimate and live member of the SMD and proceeds to roam. At block 840, the STA initiates a roaming request (e.g., a FT request or (re) association request) toward the target AP MLD and begins the handover process. If the signature verification fails, the method moves to block 845, where the STA discards the beacon and does not proceed with any roaming attempt to the target AP. The protective behavior prevents the STA from establishing a connection with an AP that may be masquerading as part of the mobility domain or attempting a MITM or replay attack.

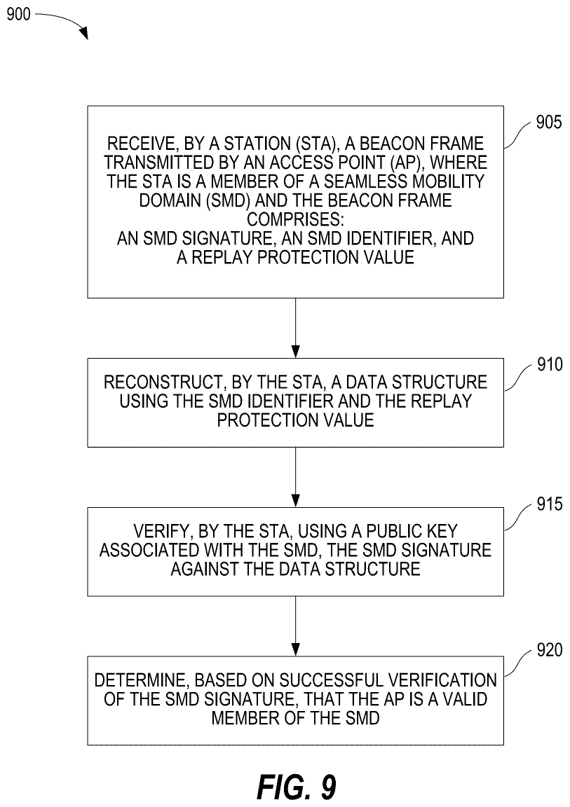

FIG. 9 is a block diagram depicting an example method 900 performed by a STA MLD for verifying an AP MLD using an SMD signature and a replay protection value, according to some embodiments of the present disclosure.

At block 905, a STA (e.g., STA 305 of FIG. 3) receives a beacon frame transmitted by an access point (AP) (e.g., AP MLD 310-2 of FIG. 3), where the STA is a member of a seamless mobility domain (SMD) and the beacon frame comprises an SMD signature, an SMD identifier, and a replay protection value.

At block 910, the STA reconstructs a data structure using the SMD identifier and the replay protection value.

At block 915, the STA verifies, using a public key associated with the SMD, the SMD signature against the data structure.

At block 920, the STA determines, based on successful verification of the SMD signature, that the AP is a valid member of the SMD.

In some embodiments, the replay protection value may comprise at least one of a nonce or a replay counter, and the replay protection value is valid within a defined time interval.

In some embodiments, the beacon frame may further comprise at least one of identity information of the AP, operating channel information, or a timestamp.

In some embodiments, the operation of reconstructing the data structure may comprise reconstructing the data structure using the SMD identifier, the replay protection value, and at least one of the identity information of the AP, the operating channel information, or the timestamp.

In some embodiments, the public key associated with the SMD may be obtained by the STA using one of received over-the-air from the AP, provisioned on the STA, or received as part of a certificate signed by a trusted certificate authority (CA).

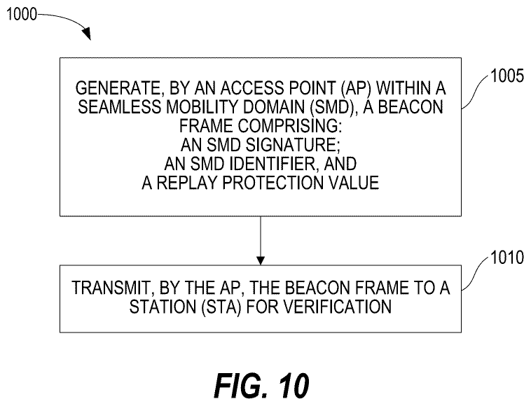

FIG. 10 is a block diagram depicting an example method 1000 performed by an AP MLD for transmitting an SMD signature with a replay protection value, according to some embodiments of the present disclosure.

At block 1005, an AP MLD (e.g., AP 310-2 of FIG. 3) within a seamless mobility domain (SMD) generates a beacon frame comprising an SMD signature, an SMD identifier, and a replay protection value, where the SMD signature is generated by signing a data structure comprising the SMD identifier and the replay protection value using a private key associated with the SMD.

At block 1010, the AP MLD transmits the beacon frame to a station (STA) (e.g., STA 305 of FIG. 3) for verification.

In some embodiments, the replay protection value may comprise at least one of a nonce or a replay counter, and the replay protection value is valid within a defined time interval.

In some embodiments, in response to determining the defined time interval has elapsed, the AP may generate a second beacon frame comprising a second SMD signature, the SMD identifier, and a second replay protection value, where the second SMD signature is generated by signing a data structure comprising the SMD identifier and the second replay protection value using the private key associated with the SMD. The AP may transmit the second beacon frame to the STA.

In some embodiments, the beacon frame may further comprise at least one of identity information of the AP, operating channel information, or a timestamp.

In some embodiments, the data structure signed for generating the SMD signature may comprise the SMD identifier and the replay protection value, and at least one of the identity information of the AP, the operating channel information, or the timestamp.

In some embodiments, the STA, upon receiving the beacon frame, may verify the SMD signature using a public key associated with the SMD.

In some embodiments, the public key associated with the SMD may be obtained by the STA using one of received over-the-air from the AP, provisioned on the STA, or received as part of a certificate signed by a trusted certificate authority (CA).

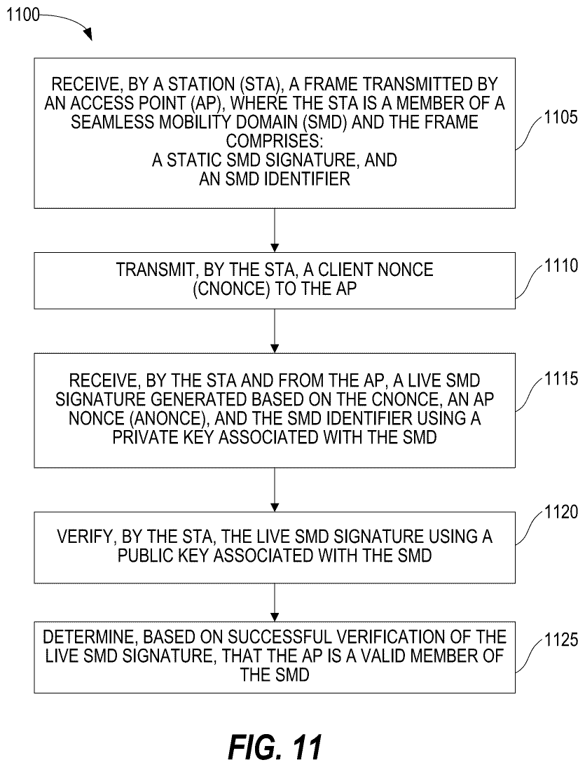

FIG. 11 is a block diagram depicting an example method 1100 performed by a STA MLD for verifying an AP MLD using a nonce exchange and live SMD signature, according to some embodiments of the present disclosure.

At block 1105, a STA (e.g., STA 405 of FIG. 4) receives a beacon frame transmitted by an access point (AP) (e.g., AP MLD 410-2 of FIG. 4), where the STA is a member of a seamless mobility domain (SMD) and the beacon frame comprises a static mobility SMD signature, and an SMD identifier.

At block 1110, the STA transmits a client nonce (CNonce) to the AP.

At block 1115, the STA receives, from the AP, a live SMD signature generated based on the CNonce, an AP nonce (ANonce), and the SMD identifier using a private key associated with the SMD.

At block 1120, the STA verifies the live SMD signature using a public key associated with the SMD.

At block 1125, the STA determines, based on successful verification of the live SMD signature, that the AP is a valid member of the SMD.

In some embodiments, the beacon frame may further comprise at least one of identity information of the AP, operating channel information, or a timestamp.

In some embodiments, the live SMD signature may be generated based on the CNonce, an AP nonce (ANonce), the SMD identifier, and at least one of the identity information of the AP, the operating class, or the channel number.

In some embodiments, the public key associated with the SMD may be obtained by the STA using one of received over-the-air from the AP, provisioned on the STA, or received as part of a certificate signed by a trusted certificate authority (CA).

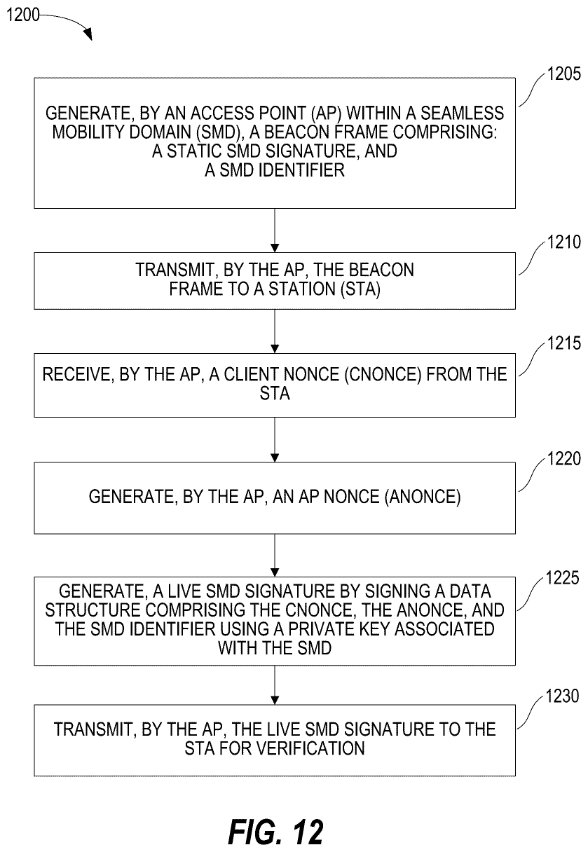

FIG. 12 is a block diagram depicting an example method 1200 performed by an AP MLD for generating and transmitting a live SMD signature in response to a STA-initiated nonce exchange, according to some embodiments of the present disclosure.

At block 1205, an AP (e.g., AP 410-2 of FIG. 4) within a seamless mobility domain (SMD) generates a beacon frame comprising a static SMD signature and an SMD identifier.

At block 1210, the AP transmits the beacon frame to a STA (e.g., STA 405 of FIG. 4).

At block 1215, the AP receives a client nonce (CNonce) from the STA.

At block 1220, the AP generates an AP nonce (ANonce).

At block 1225, the AP generates a live SMD signature by signing a data structure comprising the CNonce, the ANonce, and the SMD identifier using a private key associated with the SMD.

At block 1230, the AP transmits the live SMD signature to the STA for verification.

In some embodiments, the beacon frame may further comprise at least one of identity information of the AP, operating channel information, or a timestamp.

In some embodiments, the data structure signed for generating the SMD signature may comprise the CNonce, the ANonce, and the SMD identifier, and at least one of the identity information of the AP, the operating class, or the channel number.

In some embodiments, the operation of generating the live SMD signature may comprise transmitting, by the AP, the data structure to a trusted entity holding the private key associated with the SMD, where the trusted entity generates the live SMD signature by signing the data structure using the private key, and receiving, by the AP, the live SMD signature from the trusted entity.

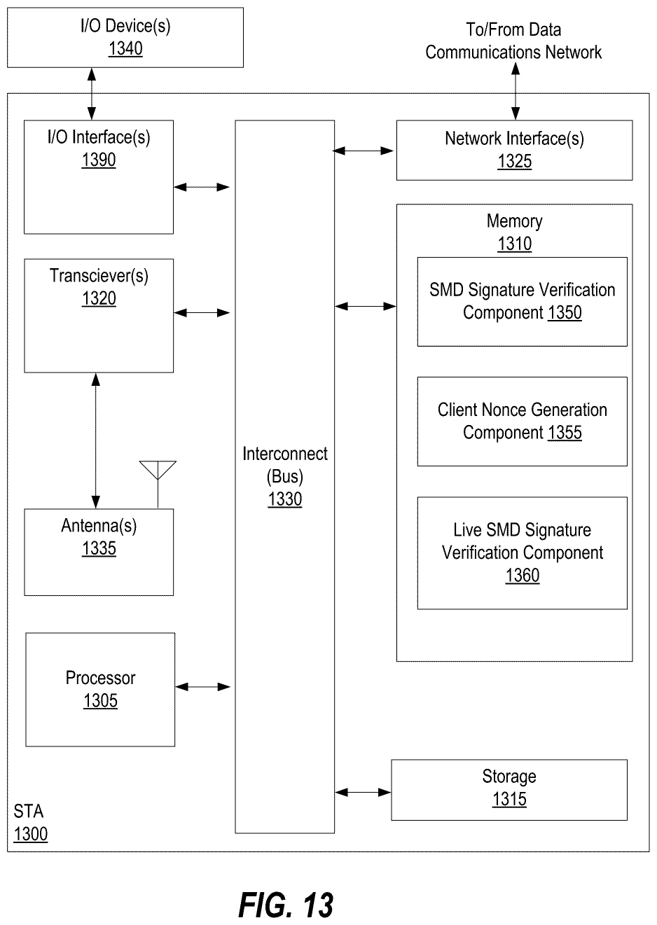

FIG. 13 depicts an example client device 1300 configured to perform various aspects of the present disclosure, according to some aspects of the present disclosure. The example client device 1300 may correspond to a STA as depicted in FIGS. 1-4.

As illustrated, the client device 1300 includes a processor 1305, memory 1310, storage 1315, one or more transceivers 1320, one or more I/O interfaces 1390, and one or more network interfaces 1325. In some embodiments, I/O devices 1340 are connected via the I/O interface(s) 1380. Further, via the network interface 1325, the client device 1300 can be communicatively coupled with one or more other devices and components (e.g., via a network, which may include the Internet, local network(s), and the like). Each of the components is communicatively coupled by one or more buses 1330. In some embodiments, one or more antennas 1335 may be coupled to the transceivers 1320 for transmitting and receiving wireless signals.

The processor 1305 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1305 processes information received through the transceiver 1320, I/O interfaces 1390, and the network interfaces 1325. The processor 1305 retrieves and executes programming instructions stored in memory 1310, as well as stores and retrieves application data residing in storage 1315.

The storage 1315 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1315 may store a variety of data for the efficient functioning of the system.

The memory 1310 may include random access memory (RAM) and read-only memory (ROM). The memory 1310 may store processor-executable software code containing instructions that, when executed by the processor 1305, enable the client device 1300 to perform various functions described herein for wireless communication.

When the client device 1300 operates in accordance with the embodiment depicted in FIG. 3, the memory 1310 includes an SMD signature verification component 1350. The SMD signature verification component 1350 is configured to verify an SMD signature included in a beacon or management frame. The SMD signature verification component 1350 uses a replay protection value (e.g., a nonce or replay counter), the SMD IDENTIFIER, and other signed fields to reconstruct the expected signature payload, and then validates the SMD signature using a trusted public key associated with the SMD.

When the client device 1300 operates in accordance with the embodiment depicted in FIG. 4, the memory 1310 includes a client nonce generation component 1355 and a live SMD signature verification component 1360. The client nonce generation component 1355 is configured to generate a random challenge value (CNonce) to initiate liveness verification with a target AP. The live SMD signature verification component 1345 is configured to verify a signature received in response to the nonce exchange. The live SMD signature verification component 1345 uses the received live SMD signature, the CNonce, the ANonce, and the signed operational fields to confirm the AP's liveness and membership in the SMD.

Although depicted as a discrete component for conceptual clarity, in some embodiments, the operations of the depicted components (and others not illustrated) may be combined or distributed across any number of components. Further, although depicted as software residing in memory 1310, in some aspects, the operations of the depicted components (and others not illustrated) may be implemented using hardware, software, or a combination of hardware and software.

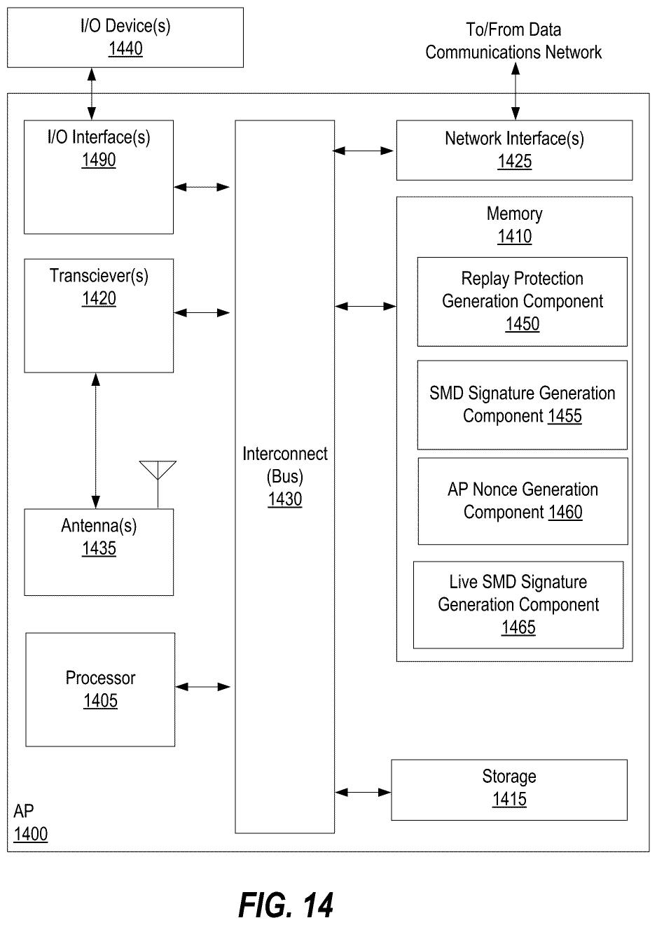

FIG. 14 depicts an example network device 1400 configured to perform various aspects of the present disclosure, according to some aspects of the present disclosure. The example network device 1400 may correspond to a target AP within an SMD, as depicted in FIGS. 1-4.

As illustrated, the network device 1500 includes a processor 1505, memory 1510, storage 1515, one or more transceivers 1420, one or more I/O interfaces 1490, and one or more network interfaces 1425. In some embodiments, I/O devices 1440 are connected via the I/O interface(s) 1480. Further, via the network interface 1425, the network device 1400 can be communicatively coupled with one or more other devices and components (e.g., via a network, which may include the Internet, local network(s), and the like). Each of the components is communicatively coupled by one or more buses 1430. In some embodiments, one or more antennas 1435 may be coupled to the transceivers 1420 for transmitting and receiving wireless signals.

The processor 1405 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1405 processes information received through the transceiver 1420, I/O interfaces 1490, and the network interfaces 1425. The processor 1405 retrieves and executes programming instructions stored in memory 1410, as well as stores and retrieves application data residing in storage 1415.

The storage 1415 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1415 may store a variety of data for the efficient functioning of the system.

The memory 1410 may include random access memory (RAM) and read-only memory (ROM). The memory 1410 may store processor-executable software code containing instructions that, when executed by the processor 1405, enable the network device 1400 to perform various functions described herein for wireless communication.

When the network device 1400 operates in accordance with the embodiment depicted in FIG. 3, the memory 1410 includes a replay protection generation component 1450 and an SMD signature generation component 1455. The replay protection generation component 1450 is configured to generate a replay protection value such as a nonce or a replay counter. The value ensures that each transmitted Beacon or management frame is cryptographically bound to a specific time or interval. The SMD signature generation component 1455 is configured to construct a data structure comprising the SMD IDENTIFIER, the generated replay protection value, and other signed parameters. The SMD signature generation component 1455 generates a static SMD signature by signing the data structure using a private key associated with the SMD. In some embodiments, the signing operation may be delegated to a trusted signing entity, such as an SMD key holder or a wireless controller.

When the network device 1400 operates in accordance with the embodiment depicted in FIG. 4, the memory 1410 includes an AP nonce generation component 1460 and a live SMD signature generation component 1465. The AP nonce generation component 1460 is configured to generate a unique ANonce in response to a CNonce received from a roaming STA. The live SMD signature generation component 1465 is configured to generate a live SMD signature over a data structure that includes the CNonce, ANonce, SMD IDENTIFIER, and AP-specific metadata. In some embodiments, the signing operation may be delegated to a trusted signing entity, such as an SMD key holder or a wireless controller. The Live SMD signature generation component 1465 may then package the input parameters, forward the data securely to the signing entity, and transmit the resulting signature and associated fields back to the requesting STA.

Although depicted as a discrete component for conceptual clarity, in some embodiments, the operations of the depicted components (and others not illustrated) may be combined or distributed across any number of components. Further, although depicted as software residing in memory 1410, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including elements A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving, by a station (STA), a frame transmitted by an access point (AP), wherein the STA is a member of a seamless mobility domain (SMD) and the frame comprises:
an SMD signature,
an SMD identifier, and
a replay protection value;
reconstructing, by the STA, a data structure using the SMD identifier and the replay protection value;
verifying, by the STA, using a public key associated with the SMD, the SMD signature against the data structure; and
determining, based on successful verification of the SMD signature, that the AP is a valid member of the SMD.

2. The method of claim 1, wherein the replay protection value is valid within a defined time interval, and the replay protection value comprises at least one of:
a nonce, or
a replay counter.

3. The method of claim 1, wherein the frame further comprises at least one of:
identity information of the AP,
operating channel information, or
a timestamp.

4. The method of claim 3, wherein reconstructing the data structure comprises:
reconstructing the data structure using the SMD identifier, the replay protection value, and at least one of:
the identity information of the AP,
the operating channel information, or
the timestamp.

5. The method of claim 1, wherein the public key associated with the SMD is obtained by the STA using one of:
received over-the-air from the AP,
provisioned on the STA, or
received as part of a certificate signed by a trusted certificate authority (CA).

6. The method of claim 1, further comprising receiving, by the STA, the public key associated with the SMD from the AP via an Access Network Query Protocol (ANQP) request and response exchange.

7. A method, comprising:
generating, by an access point (AP) within a seamless mobility domain (SMD), a frame comprising:
an SMD signature,
an SMD identifier, and
a replay protection value,
wherein the SMD signature is generated by signing a data structure comprising the SMD identifier and the replay protection value using a private key associated with the SMD; and
transmitting, by the AP, the frame to a station (STA) for verification.

8. The method of claim 7, wherein the replay protection value is valid within a defined time interval, and the replay protection value comprises at least one of:
a nonce, or
a replay counter.

9. The method of claim 8, further comprising:
in response to determining the defined time interval has elapsed, generating, by the AP, a second frame comprising:
a second SMD signature,
the SMD identifier; and
a second replay protection value,
wherein the second SMD signature is generated by signing a data structure comprising the SMD identifier and the second replay protection value using the private key associated with the SMD; and
transmitting, by the AP, the second frame to the STA.

10. The method of claim 7, wherein the frame further comprises at least one of:
identity information of the AP,
operating channel information, or
a timestamp.

11. The method of claim 10, wherein the data structure signed for generating the SMD signature comprises the SMD identifier and the replay protection value, and at least one of:
the identity information of the AP,
the operating channel information, or
the timestamp.

12. The method of claim 7, wherein the STA, upon receiving the frame, verifies the SMD signature using a public key associated with the SMD.

13. The method of claim 12, wherein the public key associated with the SMD is obtained by the STA using one of:
received over-the-air from the AP,
provisioned on the STA, or
received as part of a certificate signed by a trusted certificate authority (CA).

14. A method, comprising:
receiving, by a station (STA), a frame transmitted by an access point (AP), wherein the STA is a member of a seamless mobility domain (SMD) and the frame comprises:
an SMD signature, and
an SMD identifier;
transmitting, by the STA, a client nonce (CNonce) to the AP;
receiving, by the STA and from the AP, a live SMD signature generated based on the CNonce, an AP nonce (ANonce), and the SMD identifier using a private key associated with the SMD;
verifying, by the STA, the live SMD signature using a public key associated with the SMD; and
determining, based on successful verification of the live SMD signature, that the AP is a valid member of the SMD.

15. The method of claim 14, wherein the frame further comprises at least one of:
identity information of the AP,
operating class, or
a channel number.

16. The method of claim 15, wherein the live SMD signature is generated based on the CNonce, an AP nonce (ANonce), the SMD identifier, and at least one of:
the identity information of the AP,
the operating class, or
the channel number.

17. The method of claim 14, wherein the public key associated with the SMD is obtained by the STA using one of:
received over-the-air from the AP,
provisioned on the STA, or
received as part of a certificate signed by a trusted certificate authority (CA).

18. A method, comprising:
generating, by an access point (AP) within a seamless mobility domain (SMD), a frame comprising:
a static SMD signature, and
a SMD identifier;
transmitting, by the AP, the frame to a station (STA);
receiving, by the AP, a client nonce (CNonce) from the STA;
generating, by the AP, an AP nonce (ANonce);
generating a live SMD signature by signing a data structure comprising the CNonce, the ANonce, and the SMD identifier using a private key associated with the SMD; and
transmitting, by the AP, the live SMD signature to the STA for verification.

19. The method of claim 18, wherein the frame further comprises at least one of:
identity information of the AP,
operating class, or
a channel number.

20. The method of claim 18, wherein generating the live SMD signature comprises:
transmitting, by the AP, the data structure to a trusted entity holding the private key associated with the SMD, wherein the trusted entity generates the live SMD signature by signing the data structure using the private key; and
receiving, by the AP, the live SMD signature from the trusted entity.
